(19) United States
(12) Patent Application Publication
(10) Pub. No.: US 2005/0265543 A1
(43) Pub. Date: Dec. 1, 2005

(54) Directed messaging

(75) Inventor: Dov Moran, Kfar Saba (IL)

Correspondence Address: DR. MARK FRIEDMAN LTD.;C/o Bill Polkinghorn, Discovery Dispatch, 9003 Florin Way, Upper Marlboro, MD, 20772, US

(73) Assignee: M-SYSTEMS FLASH DISK PIONEERS LTD.

(21) Appl. No.: 10/893,334

(22) Filed: Jul. 19, 2004

Related U.S. Application Data
(60) Provisional application No. 60/575,947, filed on May 30, 2004.

(51) Int. Cl. H04M 1/00; H04M 1/56

(52) U.S. Cl. 379/373.03; 379/142.01

(57) ABSTRACT

A method for answering an incoming call from a caller to a telephone, the method including the steps of: (a) identifying the caller; (b) selecting a voice message that is intended solely for the caller; and (c) transmitting the voice message to the caller. Preferably, the identifying is performed by a user and the selecting is performed by pressing a button on the telephone. Alternatively, the identifying and the selecting are performed by a processor in the telephone or by a processor in a messaging server operationally connected to the telephone through a telephone network. Preferably, the voice message is stored in the telephone or in memory operationally connected to the messaging server.

### CROSS REFERENCE TO RELATED APPLICATION

This application claims the benefit from U.S. provisional application 60/575,947 filed on 30 May 2004 by the same inventor.

### FIELD AND BACKGROUND OF THE INVENTION

The present invention relates to telephone call answering systems and, more particularly, to a system and method for discreetly answering a telephone call and providing a previously recorded message based on the origin of the telephone call.

Mobile telephones are commonly used in many regions by a vast majority of the population. In general, the use of mobile telephones has improved the quality of life allowing mobile telephone users to be accessible by telephone when they so desire. However, the prevalent use of mobile telephones is at times a nuisance. Mobile telephones often ring at undesired times, disturbing the telephone user or others in his/her vicinity. A mobile telephone phone rings occasionally, in a very important meeting, or in a hall during a concert.

In order to avoid being disturbed by an incoming call, the user of a mobile telephone has several options. The simplest option is for the telephone user to switch off the telephone. Although switching off the telephone prevents disturbances, the telephone user is rendered completely inaccessible and he/she will not receive any urgent messages.

Consequently, most telephones have an option to receive calls silently or to vibrate quietly to minimize the disturbance while allowing a telephone owner to answer his/her calls. For both silent and vibrating operation, if an incoming call is detected, the user will generally look at the screen to identify the caller. If the user decides to answer the call, he/she is required to excuse herself from the meeting, or leave the concert in the middle and rush out before the caller gives up and terminates the call.

Another alternative for the mobile telephone user is to activate a voice mailbox with the mobile telephone either powered down or in silent mode. After activation, the voice mailbox answers incoming calls, either immediately or after a delay giving the mobile telephone user an option to receive the call before the call is diverted to the voice mailbox. Although activation of a voice mailbox is effective in avoiding disturbances, the initiator of the telephone call will not receive any feedback regarding his message until the mobile user takes the time to listen to the recorded messages and follows up with a return call. Oftentimes, the message itself is time critical and no longer relevant when the mobile user receives the message.

Frequently, there are times when the mobile telephone user is in a place that he/she wishes not to receive phone calls nor disturb others but nevertheless he/she anticipates a time critical call from a specific person and wishes to convey a message to the specific person when he/she calls. There is thus a need for, and it would be highly advantageous to have, a system and method that discreetly answers a telephone call and provides a prerecorded message based on the origin of the telephone call.

### SUMMARY OF THE INVENTION

According to the present invention there is provided a method for answering an incoming call from a caller to a telephone, the method including the steps of: (a) identifying the caller; (b) selecting a voice message that is intended solely for the caller; and (c) transmitting the voice message to the caller. Preferably, the identifying is performed by a user and the selecting is performed by pressing a button on the telephone. Alternatively, the identifying and the selecting are performed by a processor in the telephone or by a processor in a messaging server operationally connected to the telephone through a telephone network. Preferably, the voice message is stored in the telephone or in memory operationally connected to the messaging server.

According to the present invention there is provided a method for answering an incoming call from a caller to a telephone, the method including: (a) identifying the caller; (b) transmitting a previously recorded voice message to the caller; wherein the voice message is intended solely for the caller. Preferably, the identifying is performed by a user or by a processor in the telephone or by a processor in a messaging server operationally connected to the telephone through a telephone network. Preferably, the transmitting is performed by a processor in a messaging server operationally connected to the telephone through a telephone network. Preferably, the voice message is stored in the telephone or in a memory operationally connected to the messaging server.

According to the present invention there is provided a telephone including a button programmed so that upon pressing the button in response to an incoming call from a caller, a voice message is transmitted to the caller. Preferably, the telephone includes a user interface for recording said voice message and further includes storage for the voice message.

According to the present invention there is provided a messaging server in a mobile telephone network operationally connected to a mobile switching center, the messaging server including: (a) a processor for receiving telephone calls diverted from mobile stations, the telephone calls of two kinds: (i) receive-message telephone calls initiated by a caller including a voice message and a respective identifier of an intended recipient of the voice message; and (ii) transmit-message telephone calls from the intended recipient to the caller; and (b) memory; wherein upon receiving one of the receive-message telephone calls, the processor stores in the memory the voice message, a caller identifier of said caller that initiated the voice message and the recipient identifier of the intended recipient; and wherein upon receiving one of the transmit-message telephone calls from the intended recipient to the caller, the processor transmits the voice message to the intended recipient.

According to the present invention there is provided a user interface installed in a telephone, the user interface including: (a) an input mechanism for storing identifiers of respective recipients; and (b) a memory for storing voice messages intended solely for the respective recipients. Preferably, the user interface further includes a button for transmitting voice messages, a processor operative to list voice messages, a microphone for recording voice messages, an erasing input mechanism (e.g., a keypad button) for erasing voice messages, a speaker for listening to voice messages, a display for verifying that voice messages have been received by the respective recipients and a canceling input mechanism (e.g., a keypad button) for canceling the transmitting of voice messages intended solely for the respective recipients.

According to the present invention there is provided a method for directing messages in a mobile telephone network including the steps of: (a) receiving telephone calls diverted from mobile stations, the telephone calls of two types: (i) receive-message telephone calls initiated by a caller including a voice message and a respective identifier for an intended recipient of the voice message; and (ii) transmit-message telephone calls from the intended recipient to said caller; and (b) upon receiving one of the receive-message telephone calls, storing in memory the voice, message, a caller identifier of said caller that initiated the voice message and the respective identifier of the intended recipient; and (c) upon receiving one of the transmit-message telephone calls from the intended recipient to the caller, transmitting the voice message to the intended recipient.

### BRIEF DESCRIPTION OF THE DRAWINGS

The invention is herein described, by way of example only, with reference to the accompanying drawings, wherein:

FIG. 1 is a simplified schematic drawing of a system for directing messages. according to an embodiment of the present invention;

FIG. 2 is a simplified drawing showing a menu structure of a system for directed messaging according to an embodiment of the present invention;

FIG. 3 is a flow chart of a method for creating new voice messages, according to an embodiment of the present invention;

FIG. 4 is a flow chart of a method for discreetly receiving a phone call, according to an embodiment of the present invention;

FIG. 5 is a simplified schematic drawing of a system for directing messages. according to an embodiment of the present invention;

FIG. 6 is a flow chart of a method for directed voice messaging, according to an embodiment of the present invention;

FIG. 7 is a flow chart of a menu structure for verifying that a call has been received and answered, according to an embodiment of the present invention.

### DESCRIPTION OF THE PREFERRED EMBODIMENTS

The present invention is of a system and method for discreetly answering a telephone call and providing a prerecorded message based on the origin of the telephone call. Specifically, the present invention can be used to record messages in anticipation of receiving a time critical telephone call from a known party and using the recorded message to respond discreetly without disturbing others in the vicinity of the mobile telephone user.

The principles and operation of a system and method for discreetly answering a telephone call and providing a prerecorded message based on the origin of the telephone call, according to the present invention may be better understood with reference to the drawings and the accompanying description.

Before explaining embodiments of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

By way of introduction, two principle intentions of the present invention are to: (1) provide the user of a mobile telephone with a method to record messages for responding to anticipated time critical telephone calls and (2) provide a method of using the recorded messages to respond to the time critical call discreetly without disturbing others in the vicinity of the mobile telephone user. It should be noted that while the discussion herein is directed to a public cellular mobile network, the principles of the present invention may be adapted for use in, and provide benefit for other types of wireless communications including private wireless networks, iDEN (MIRS), paging services, and satellite communications. The present invention may be adapted as well for wired telephone networks. Further the mechanism for storing voice messages may be of any such mechanisms known in the art, including analog media, and digital storage media including random access memory, flash memory, and EEPROM. The terms “storage” and “memory” are used herein interchangeably and refer to any such storage mechanisms.

Referring now to the drawings, FIG. 1 illustrates a sub-system 10 for storing and listening to voice messages using a digital mobile telephone 101. Mobile telephone 101 includes a microphone 102 for converting a voice to an electrical signal. Mobile telephone 101 further includes an analog to digital converter (A/D) operatively connected to microphone 102. Intermediary stages for analog amplification and filtering found in mobile telephone 101 after microphone 102 are not shown in FIG. 1. Mobile telephone 101 further includes a digital signal processor (DSP) 105, for compressing, encoding and further processing the digital data representing the audio signal as received in microphone 102. Sub-system 10 for storing messages in mobile telephone 101 further includes an audio storage 111. Mobile telephone 101 includes a digital to analog converter (D/A) 107 operatively connected to a speaker 109. Intermediary stages found in mobile telephone 101 for amplification between D/A 107 and speaker 109 are not shown in FIG. 1.

Mobile telephone 101 further includes a user interface 20 including a display 106, an input mechanism, e.g a keypad 110, a processor 104 and a memory 112 for storing software instructions to be run by processor 104. Mobile telephone 101 further includes a button 108, used for transmitting pre-recorded messages. The term “button” is defined herein to refer to any input mechanism to user interface 20 of mobile telephone 101, including a physical button, or an icon on display 106. The terms “button” and input mechanism are used herein interchangeably.

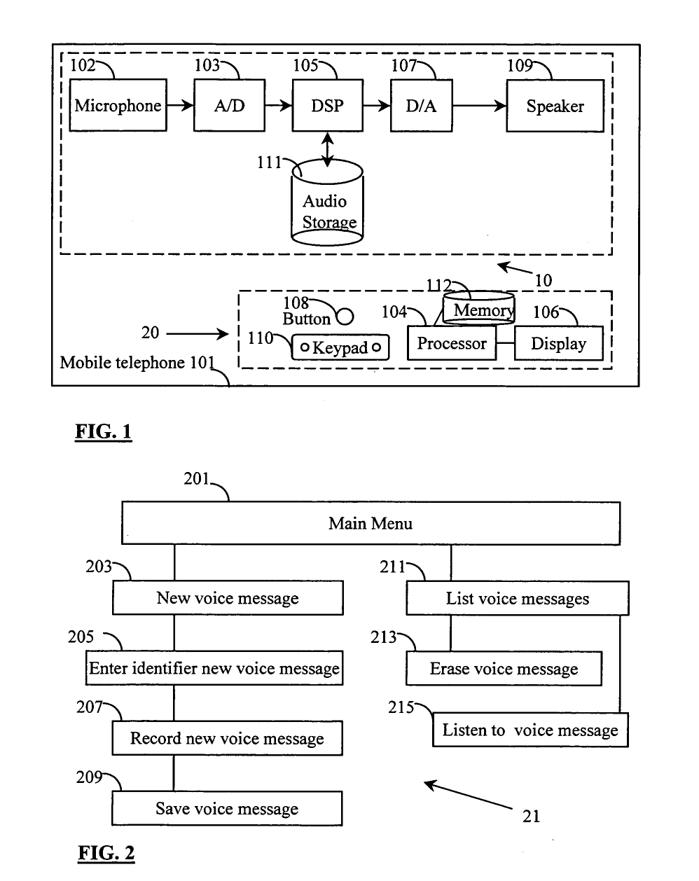

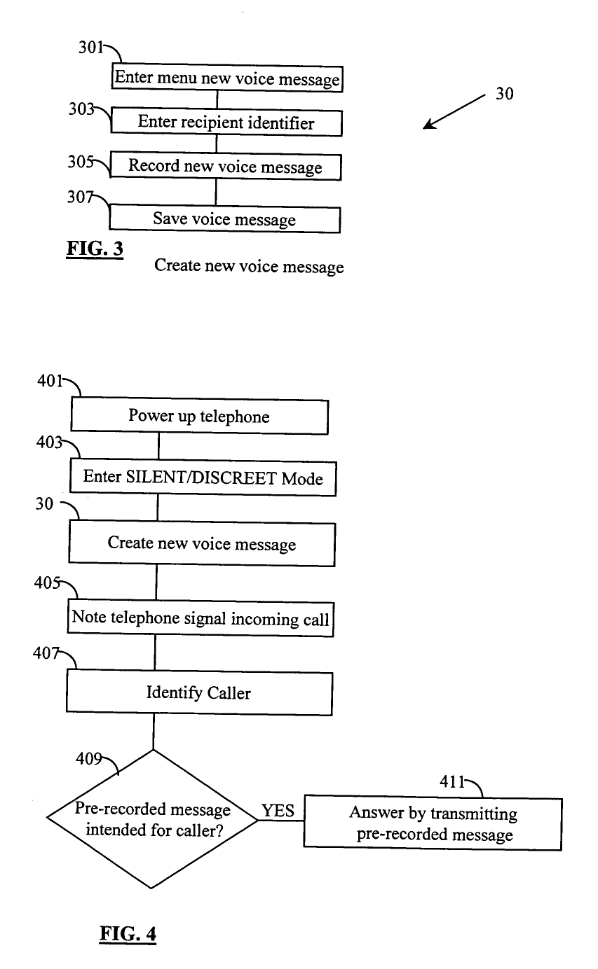

Referring now to FIG. 2, a menu structure 21 stored in memory 112 and operative by processor 104, is shown for recording voice messages according to an embodiment of the present invention. The menu structure includes a main menu 201 with the usual sub-menus (not shown) included in prior art mobile telephones. Menu structure 21 further includes options to choose a new voice message 203, enter an identifier of an intended recipient, e.g name or a telephone number for a new voice message 205, record a new voice message 207 and save a new voice message 209 in audio storage 111. Menu structure 21 further includes options to list voice messages 211 previously stored, for instance, in audio storage 111; erase previously stored voice messages 213 and to listen to voice messages 215 using speaker 109. Referring now to FIG. 3, method 30 is shown for creating and storing a new voice message. The mobile user presses the appropriate button(s), for instance, on keypad 110 to enter (step 301) the voice message menu. Optionally, the user presses the appropriate button(s) on keypad 110 to open a text screen to enter an identifier (step 303), such as a name from the phone book stored in mobile telephone 101 or a telephone number. The identifier indicates for whom the message is intended. Then the user records (step 305) a new voice message by speaking into microphone 102 and saves (step 307) the newly recorded voice message in storage 111 by pressing the appropriate button(s) on keypad 110.

The operation of discreetly answering a telephone call and providing a prerecorded message based on the origin of the telephone call, according the present invention, is best understood with a real life example as follows:

Sarah, a well known music critic, carries mobile telephone 101 equipped with sub-system 10 for recording messages and she is familiar with the new features shown in menu structure 21. Sarah intends to attend a concert and meet her husband Joe and family for dinner after the concert is over. Since Sarah's mobile telephone 101 will be powered down during the concert, they arrange that Joe will call Sarah and leave a message for Sarah on her voice mail box indicating to which restaurant Sarah should go after the concert. Unfortunately, the intermission was too long, Sarah's plans changed and Sarah scheduled to meet the musicians after the concert. She would like to get a message to Joe and family to eat dinner without her and Joe should pick Sarah up at the front gate of the concert hall at 10:00 PM. Just before returning to the concert after intermission, Sarah places a call to Joe's mobile phone. Unfortunately, Joe does not answer. Sarah chooses not to leave a message on Joe's voice mailbox because Joe never checks his voice mail or alternatively, she wants to be sure Joe receives her message. Sarah then recalls the features of menu structure 21. Referring also to FIG. 4, Sarah powers up (step 401) mobile telephone 101. Sarah presses a button for entering (step 403) a silent mode or otherwise a discreet mode. Sarah then follows according to method 30 (FIG. 3) for creating and storing a new voice message. Sarah then records the message (step 305), “Darling, I can't come for dinner but pick me up at ten o'clock at the front gate”.

Sarah sits down in her seat at the concert with mobile telephone 101 in hand to make sure she doesn't miss an incoming call. During the concert, Sarah notes (step 405) an mobile telephone 101 signaling an incoming call, by vibrating quietly, and identifies (step 407) the caller as Joe by viewing display 106. Since the recorded message is intended for Joe (decision block 409), she presses button 108 to answer (step 411) the incoming call, transmitting her pre-recorded message to Joe and maintaining discretion in the concert hall.

According to an alternative embodiment of the present invention, during method 30 for creating a new voice message, Sarah presses a button (step 303) to enter a name for the new message. Sarah enters the name “Joe”. Alternatively, she enters Joe's mobile telephone number. Mobile telephone 101 is programmed to identify (step 407) the caller and automatically answer (step 411) with the recorded message intended for Joe.

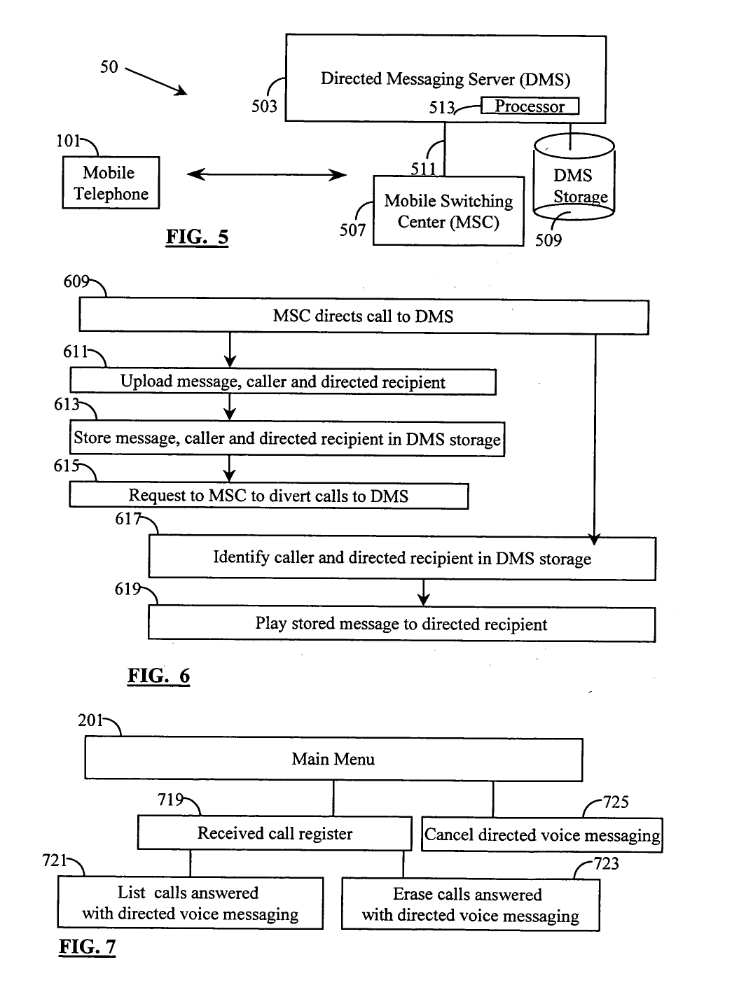

Another possible configuration 50 for the present invention is shown in FIG. 5. FIG. 5 illustrates mobile telephone 101 in communication with a mobile switching center (MSC) 507 as part of, for instance, a public mobile telephone network. Mobile switching center (MSC) 507 is operatively connected, e.g. by a wireless or wired connection, to a directed messaging server (DMS) 503 including a processor 513 and an interface 511 with MSC 507. Directed messaging server (DMS) is operatively connected to DMS data storage 509. According to the operation of configuration 50, directed messages are stored together with identifiers of both the initiator of the directed message and the recipient of the directed message, e.g. Sarah as the initiator and Joe as the recipient. The operation of configuration 50 is best described by returning to the example of Sarah and Joe. Referring back to method 30 of creating a new voice message, Sarah enters the name Joe (step 303), records (step 305) a new voice message intended only for Joe, and saves (step 307) the voice message.

Referring now to FIG. 6 showing the operation of configuration 50, step 307 of saving the voice message causes mobile telephone 101 to call DMS 503, mediated (step 609) by MSC 507. Sarah's voice message is uploaded (step 611) with an identifier for Sarah, e.g Sarah's phone number and an identifier for Joe, e.g. Joe's phone number. Both identifiers, of caller Sarah and directed recipient Joe and the message are stored (step 613) in DMS storage 509. DMS 503 requests (step 615) MSC 507 to divert any call from Joe to Sarah to DMS 503 for handling. When Joe calls Sarah, MSC 507 directs (step 609) the call to DMS 503. DMS 503 identifies (step 617) Joe and Sarah in DMS storage 509 and plays (step 619) Sarah's message to Joe 619.

In some embodiments of directed messaging, such as the method shown in FIG. 4, the message is transmitted to the intended recipient manually, such as by pressing button 108 on mobile telephone 101. In other embodiments such as that shown in FIGS. 5 and 6, the message is transmitted to the intended recipient automatically. Returning to our example, Sarah doesn't know if Joe received her message. Therefore, a menu is required for determining if the directed message has been received. Referring now to FIG. 7, under main menu 201 there is a standard menu option 719 “received call register” for listing all received calls. Within menu option “received call register” 719, is an additional option 721 for listing all calls answered with directed voice messaging. Directed voice messaging information is stored in mobile telephone 101; alternatively directed voice messaging information is stored in DMS 503 and is retrieved by mobile telephone 101 by placing a telephone call to DMS 503. Additional menu options shown in FIG. 7 include menu option 723 to erase entries of calls answered with directed voice messaging from the received call register 725 and menu option 725 to cancel directed voice messaging by placing a call to DMS 503 with a null message or otherwise canceling the feature within mobile telephone 101.

Getting back to Sarah, she presses the appropriate button(s) on keypad 110 to enter menu option 721 to list all calls answered with directed voice messaging. Sarah reads from the received call register and verifies by pressing the appropriate button(s) on keypad 110 that Joe placed a call at 9:35 PM that evening and was answered automatically with the directed voice message. Sarah then chooses menu option 723 and she erases Joe's call from the received call register by pressing the appropriate button(s) on keypad 110. Since Sarah no longer requires directed voice messaging, she chooses a menu option 725 and presses the appropriate button(s) on keypad 110 to cancel directed voice messaging and she proceeds to the front entrance of the concert hall where Joe is waiting.

With respect to the above description then, it is to be realized that the optimum function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

While the invention has been described with respect to a limited number of embodiments, it will be appreciated that many variations, modifications and other applications of the invention may be made.

1. A method for answering an incoming call from a caller to a telephone, the method comprising the steps of:
(a) identifying the caller;
(b) selecting a voice message that is intended solely for the caller; and
(c) transmitting said voice message to the caller.

2. The method, according to claim 1, wherein said identifying is performed by a user.

3. The method, according to claim 1, wherein said selecting is performed by pressing a button on the telephone, thereby triggering said transmitting.

4. The method, according to claim 1, wherein said identifying is performed by a processor in the telephone.

5. The method, according to claim 1, wherein said selecting is performed by a processor in the telephone.

6. The method, according to claim 1, wherein said identifying is performed by a processor in a messaging server operationally connected to the telephone through a telephone network.

7. The method, according to claim 1, wherein said selecting is performed by a processor in a messaging server operationally connected to the telephone through a telephone network.

8. The method, according to claim 1, wherein said voice message is stored in the telephone.

9. The method, according to claim 7, wherein said voice message is stored in a memory operationally connected to said messaging server.

10. A method for answering an incoming call from a caller to a telephone, the method comprising the steps of:
(a) identifying the caller;
(b) transmitting a previously recorded voice message to the caller;
wherein said voice message is intended solely for the caller.

11. The method, according to claim 10, wherein said identifying is performed by a user.

12. The method, according to claim 10, wherein said identifying is performed by a processor in the telephone.

13. The method, according to claim 10, wherein said identifying is performed by a processor in a messaging server operationally connected to the telephone through a telephone network.

14. The method, according to claim 10, wherein said transmitting is performed by a processor in a messaging server operationally connected to the telephone through a telephone network.

15. The method, according to claim 10, wherein said voice message is stored in the telephone.

16. The method, according to claim 14 wherein said voice message is stored in a memory operationally connected to said messaging server.

17. A telephone comprising a button programmed so that upon pressing said button in response to an incoming call from a caller, a voice message is transmitted to said caller.

18. The telephone, according to claim 17, further comprising a user interface for recording said voice message.

19. The telephone, according to claim 17, further comprising a memory for storing said voice message.

20. A messaging server in a mobile telephone network operationally connected to a mobile switching center, the messaging server comprising:
(a) a processor for receiving telephone calls diverted from mobile stations, the telephone calls selected from the group consisting of:
(i) receive-message telephone calls initiated by a caller and including a voice message and a respective identifier of an intended recipient of said voice message; and
(ii) transmit-message telephone calls from said intended recipient to said caller; and
(b) a memory;
wherein upon receiving one of said receive-message telephone calls, said processor stores in said memory, said voice message, a caller identifier of said caller that initiated said voice message, and said respective identifier of said intended recipient; and
wherein upon receiving one of said transmit message telephone calls from said intended recipient to said caller, said processor transmits said voice message to said intended recipient.

21. A user interface installed in a telephone, the user interface comprising:
(a) an input mechanism for storing a respective identifier of at least one recipient; and
(b) a memory for storing a respective voice message intended solely for each said at least one recipient.

22. The user interface, according to claim 21, further comprising:
(c) a button for transmitting said respective voice message.

23. The user interface, according to claim 21, further comprising:
(c) a processor operative to list said at least one voice message.

24. The user interface, according to claim 21, further comprising:
(c) a microphone for recording said at least one voice message.

25. The user interface, according to claim 21 further comprising:
(c) an erasing input mechanism for erasing said at least one voice message.

26. The user interface, according to claim 21, further comprising:
(c) a speaker for listening to said at least one voice message.

27. The user interface, according to claim 21, further comprising:
(c) a display for verifying that said at least one voice message has been received by said respective at least one recipient.

28. The user interface, according to claim 21, further comprising:
(c) a canceling input mechanism for canceling said transmitting.

29. A method for directing messages in a mobile telephone network comprising the steps of:
(a) receiving telephone calls diverted from mobile stations, the telephone calls selected from the group consisting of:
(i) receive-message telephone calls initiated by a caller including a voice message and a respective identifier for an intended recipient of said voice message; and
(ii) transmit-message telephone calls from said intended recipient to said caller; and
(b) upon receiving one of said receive-message telephone calls, storing in a memory said voice message, a caller identifier of said caller that initiated said voice message and said respective identifier of said intended recipient; and
(c) upon receiving one of said transmit message telephone calls from said intended recipient to said caller, transmitting said voice message to said intended recipient.
